(19) United States
(12) Patent Application Publication
(10) Pub. No.: US 2005/0210241 A1
(43) Pub. Date: Sep. 22, 2005

(54) Method and apparatus for digital rights management using certificate revocation list

(75) Inventors: Byung-rae Lee, Yongin-si (KR); Tae-sung Kim, Seoul (KR); Kyung-im Jung, Seongnam-si (KR); Yun-sang Oh, Seoul (KR); Shin-han Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/085,468

(22) Filed: Mar. 22, 2005

Related U.S. Application Data
(60) Provisional application No. 60/575,757, filed on Jun. 1, 2004.

(30) Foreign Application Priority Data
Mar. 22, 2004 (KR) 10-2004-0019441
May 31, 2004 (KR) 10-2004-0039380

(51) Int. Cl. H04L 9/00

(52) U.S. Cl. 713/158

(57) ABSTRACT

A digital rights management method includes a stage for a device to update a Certificate Revocation List of the device through a connection to a portable storage, a stage to access to the updated Certificate Revocation List so as to judge the effectiveness of a certificate of the portable storage, and a stage to maintain communication with the portable storage, if the judgment proves the effectiveness of the portable storage.

### CROSS-REFERENCE TO RELATED APPLICATIONS

This application claims priority from Korean Patent Application Nos. 10-2004-0019441 and 10-2004-0039380 filed on Mar. 22 and May 31, 2004 respectively in the Korean Intellectual Property Office, and U.S. Provisional Application No. 60/575,757 filed on Jul. 1, 2004 in the United States Patent and Trademark Office, the disclosures of which are incorporated herein by reference in their entireties.

### BACKGROUND OF THE INVENTION

1. Field of the Invention

The present invention relates to a method and an apparatus for digital rights management, and more particularly, to a method and an apparatus for digital rights management whereby security is tightened in communication between a portable storage and a device, by using a certificate revocation list.

2. Description of the Related Art

Recently digital rights management (hereinafter referred to as “DRM”) has been researched actively and commercial services using this DRM have already been used or will be used.

Digital data, unlike analog data, can be readily copied without loss, reused, processed and distributed to third parties. Copying and distribution of digital data are available with a very small amount of cost. However, a large amount of cost, effort and time are needed to produce digital content composed of the digital data. For this reason, there has been a need for a technique to protect a variety of digital copyrights. According to this, the applicable range of DRM has been extended gradually.

Some efforts have been made to protect the digital content. Conventionally, digital content protection has been concentrated on preventing an access to digital content without permission. For example, only those people who have paid charges are permitted to access the digital content, and persons who have not paid the charges are denied permission to access the digital content. However, when a person who has paid the charges accesses the digital content and intentionally distributes it to a third party, the third party can use the digital content without paying the charges, from which a number of problems have been caused.

In DRM, anyone is allowed to freely access the encoded digital content, but a license is needed to decode and execute the digital content. Accordingly, the digital content can be more effectively protected by using the DRM.

FIG. 1 shows a general concept of DRM. DRM mainly covers content protected by encryption or scrambling (hereinafter referred to as encrypted content) and licenses for access to encrypted content.

In FIG. 1, there are devices 110 and 150 desiring to access encrypted content, a content provider 120 supplying the content, a rights object issuer (RI) 130 issuing rights objects (RO) that include licenses available for executing the content, and a certification authority 140 issuing certificates.

From the content provider 120, device 1 10 can obtain a desired content that is encrypted content. From the rights object issuer 130, device 110 can purchase a rights object containing a license, and then device 110 can use the encrypted content.

As the encrypted content can be freely circulated or distributed, device 110 can freely deliver the encrypted content to device 150. In order to reproduce the encrypted content delivered, device 150 also needs to have a rights object, which can be obtained from the rights object issuer 130.

The certification authority 140 issues a certificate showing an identifier of the device whose public key is identified, a serial number of the certificate, the name of the certification authority issuing the certificate, the public key of the concerned device, and a duration of the certificate. Each device can confirm through the certificate issued from the certification authority 140 whether a target device in communication with itself is authorized.

Each certificate is endorsed with a private key of the certification authority 140 to confirm if approved, and a device can confirm the certificate of target device in communication with itself using the public key of certification authority 140.

The certificate can be stored in a place easily accessible from each device, such as in a directory service system, or inherently in each device.

In order to reinforce the security in communication, every device has to secure its own certificate from the certification authority 140. However, the certificates issued from the certification authority 140 may be revoked before they expire. For example, when the secret key of a certain device is damaged, disclosed or otherwise compromised, the certificate of the concerned device can be revoked to thereby allow the target device to recognize it.

Various methods to recognize if a certificate whose validity has not expired has been revoked have been proposed. One of them is to store all the certificates of effective devices on line in an easily accessible directory service system so that target devices can use them. For example, when a device desires to access a server, the server can confirm whether the device has an existing certificate by accessing the directory service system. When the certificate does not exist in the directory service system, the server judges that the certificate of that device has been revoked.

Another method to confirm whether a certificate has been revoked is for the certification authority to issue a certificate revocation list (CRL), which refers to a list of revoked certificates.

FIG. 2 shows a structure of a certificate revocation list of X.509 V2.

Referring to FIG. 2, a certificate revocation list comprises a version, a signature algorithm ID, an issuer name, this update (date of this update), next update (date of next update), revoked certificates, certificate revocation list extensions and an issuer signature.

The version identifies a version of the certificate revocation list, the signature algorithm ID includes an algorithm ID used to sign the certificate revocation list. The issuer name is used to identify the certification authority that signs the certificate revocation list. This update identifies the issue date of the current certificate revocation list, and the next update identifies that the next certificate revocation list would be issued in the identified term.

The revoked certificates represent a list of revoked certificates, which includes serial numbers of the revoked certificates, certificate revocation dates and CRL entry extensions. The CRL entry extensions may include, for example, reason codes, hold instruction codes, invalidity dates and certificate issuers.

The issuer signature may include a digital signature on the certificate revocation list. The CRL extensions may include an authority key identifier, an issuer alternative name, a CRL number, a delta CRL indicator and an issuing distribution point.

The certificate revocation list is updated on a regular or irregular basis to be then newly issued, and may be distributed by the certification authority. By searching the certificate revocation list issued recently, each device judges a target device in communication with itself to have an effective certificate if its certificate is not included in the certificate revocation list. However, if the certificate thereof is included in the certificate revocation list, the concerned device judges the target device to be unauthorized and then terminates communication with the target device.

As described above, DRM can contribute to giving the digital content industry a boost by protecting the profits of digital content producers and suppliers.

Besides direct transfer of a rights object or encrypted content between device 110 and device 150 as illustrated in FIG. 1, new technology to transfer a rights object and encrypted content through the portable storage has recently been attempted.

Under this technology, a device may store a rights object in a portable storage or use encrypted content using the rights object stored in the portable storage. In this respect, there is a growing need to apply the DRM function to communication between a device and a portable storage.

### SUMMARY OF THE INVENTION

Illustrative, non-limiting embodiments of the present invention overcome the above disadvantages, and other disadvantages not described above.

Accordingly an aspect of the present invention is to reinforce the DRM function between a portable storage and a device using an updated certificate revocation list.

According to an exemplary embodiment of the present invention, a digital rights management method includes a stage for a device to update a Certificate Revocation List of the device through connection to a portable storage, a stage to access the updated Certificate Revocation List so as to judge the effectiveness of a certificate of the portable storage, and a stage to keep communication with the portable storage if the judgment proves the effectiveness of the portable storage.

According to another exemplary embodiment of the present invention, a digital rights management method includes a stage for a portable storage to update a Certificate Revocation List of the portable storage through connection to a device, a stage to access the updated Certificate Revocation List so as to judge the effectiveness of a certificate of the device, and a stage to keep communication with the device if the judgment proves the effectiveness of the device.

According to a further exemplary embodiment of the present invention, a device capable of digital rights management includes an interface for connecting with a portable storage, and a storage module to store a first Certificate Revocation List. The device also includes a control module that compares the issued date information of a second Certificate Revocation List received from the portable storage connected through the interface with the issued date information of the first Certificate Revocation List stored in the storage module, and updates the first Certificate Revocation List depending on the result of said comparison.

According to a still further exemplary embodiment of the present invention, a portable storage capable of digital rights management includes an interface for connecting with a device, and a storage module to store a second Certificate Revocation List. The portable storage also includes a control module that compares the issued date information of a first Certificate Revocation List received from the device connected through the interface with the issued date information of the second Certificate Revocation List stored in the storage module, and updates the second Certificate Revocation List depending on the result of said comparison.

### BRIEF DESCRIPTION OF THE DRAWINGS

The above aspects and advantages of the present invention will become more apparent by describing in detail exemplary embodiments thereof with reference to the attached drawings in which:

FIG. 1 shows a general concept of DRM;

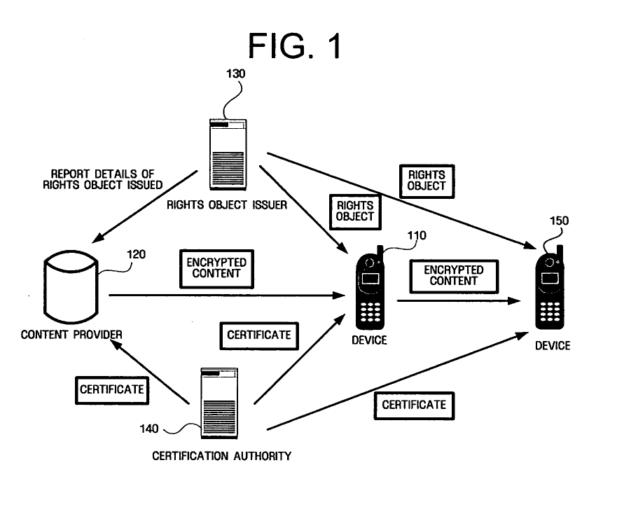

FIG. 2 shows a structure of an X.509 V2 certificate revocation list;

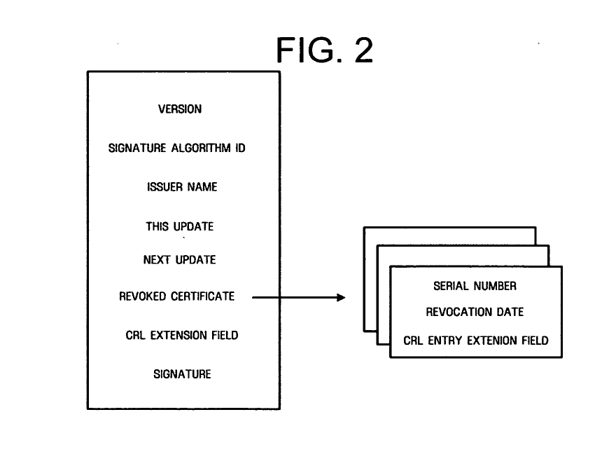

FIG. 3 is a schematic diagram illustrating a concept of digital rights management (DRM) between a portable storage and a device;

FIG. 4 illustrates a format of a rights object in accordance with an exemplary embodiment of the present invention;

FIG. 5 is a table that identifies types of constraints which each license in FIG. 4 may have;

FIG. 6 shows an example of mutual authentication between a device and a multimedia card;

FIG. 7 shows a DRM process to which a send sequence counter is applied in accordance with an exemplary embodiment of the present invention;

FIG. 8 shows a CRL updating process between a device and a multimedia card in accordance with an exemplary embodiment of the present invention;

FIG. 9 shows a CRL updating process between a device and a multimedia card in accordance with another exemplary embodiment of the present invention;

FIG. 10 shows a CRL updating process between a device and a multimedia card in accordance with a further exemplary embodiment of the present invention;

FIG. 11 shows a CRL updating process between a device and a multimedia card in accordance with a still further exemplary embodiment of the present invention;

FIG. 12 is a block diagram that shows a portable storage available for DRM in accordance with an exemplary embodiment of the present invention; and

FIG. 13 is a block diagram that shows a construction of a device available for DRM in accordance with an exemplary embodiment of the present invention.

### DETAILED DESCRIPTION OF EXEMPLARY EMBODIMENTS

Hereinbelow, exemplary embodiments of the present invention will be described in detail with reference to the accompanying drawings.

Several terms used herein will first be described in a brief manner for better understanding of the present description. Thus, it should be noted that this description is not intended to limit the scope of protection of the present invention as defined by the appended claims.

Public-key Cryptography

Public-key cryptography is also referred to as asymmetric cryptography because encryption is made when a key used in decrypting data and a key used in encrypting the data constitute different encryption keys.

In public-key cryptography, an encryption key consists of a pair of a public key and a private key. The public key needs not be kept secret, i.e., the public may easily obtain access to the public key, while the private key must be known only to a specific device. A public key encryption algorithm has been disclosed to the general public, but a third person cannot know or hardly know the original content from the encryption algorithm, encryption key and ciphered text. Examples of public key encryption algorithms are Diffie-Hellman, RSA, El Gamal, Elliptic Curve, etc. In the public key encryption method, data encryption speed is approximately 100 to 1,000 times slower than in a symmetric key encryption method. Thus, public-key cryptography is primarily used for key exchange, digital signature, etc., rather than for encryption of content itself.

Symmetric-key Cryptography

Symmetric-key cryptography is also referred to as secret key cryptography, wherein encryption is made when a key used to encrypt data and a key used to decrypt the data constitute the same encryption key.

An example of such a symmetric key encryption method is the DES method, which is the most generally used method, although applications adopting the AES method have increased.

Digital Signature

A digital signature is used to represent that a document has been drafted by the signatory. Examples of digital signature methods include RSA, El Gamal, DSA, Schnorr, etc. In the RSA digital signature method, a sender of an encrypted message transmits the message encrypted with its own private key and a receiver decrypts the encrypted message with the sender's public key. By doing so, it is proved that the message was encrypted by the sender.

Random numbers

Random numbers are numbers or strings having randomness. However, pseudo-random numbers may be used since creating true random numbers has a high cost.

Portable storage

A portable storage used in the present invention comprises a non-volatile memory with the properties of being readable, writable and erasable, like a flash memory, and is a storage device connectable to another device. Examples of such a storage device are smart media, memory stick, compact flash (CF) card, XD card, multimedia card, etc. Hereinafter, the present invention will be described by focusing on the multimedia card for purposes of illustration.

Rights Object

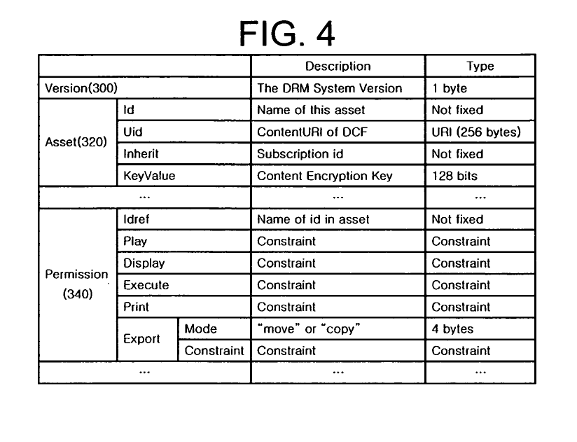

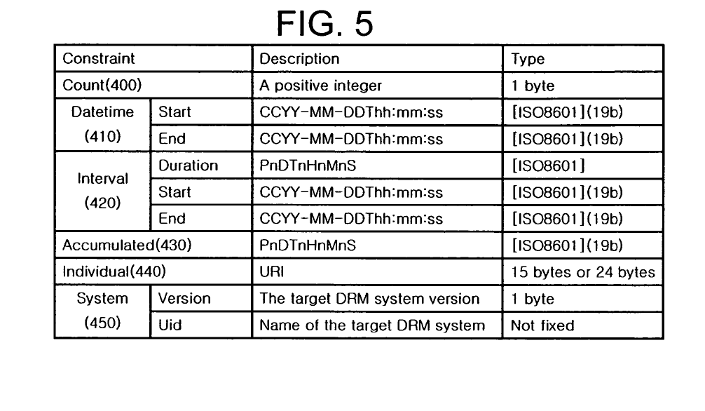

A rights object is a sort of license defining the rights to use encrypted content and any constraints on the rights, etc. The rights object used in the present invention will be described in detail with reference to FIGS. 4 and 5.

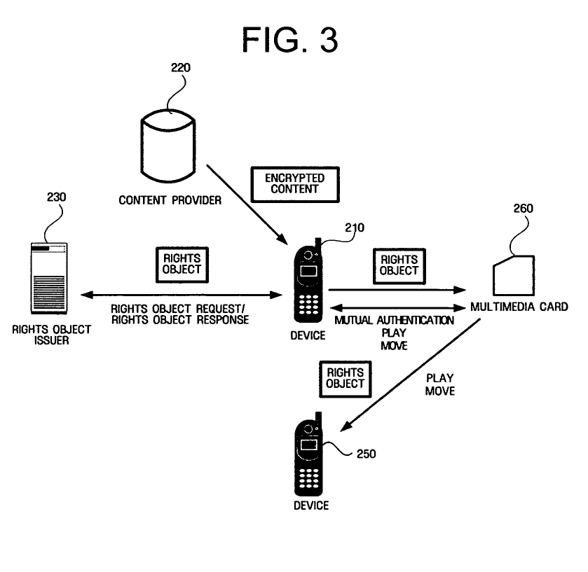

FIG. 3 explains a concept of DRM between a multimedia card and a device.

Device 210 can obtain encrypted content from the content provider 220. The encrypted content means the content protected by DRM. Use of the encrypted data requires a rights object for the content.

Device 210 having obtained the encrypted content can purchase a rights object from the rights object issuer 230, to secure a license to use the content. Device 210 having purchased the rights object from the rights object issuer 230 can use the encrypted content by use of the rights object.

To deliver the rights object to device 250, device 210 may deliver it using a portable storage. As an exemplary embodiment, a portable storage may be a multimedia card 260 possessing the DRM function. Each embodiment of the present invention will be described as employing a multimedia card 260 by way of example for the portable storage, but the present invention is not to be limited by this description.

Device 210 performs a mutual authentication with the multimedia card 260 and can then move or copy the rights object to the multimedia card 260. Thereafter, when device 210 desires to play the encrypted content, it requests the multimedia card 260 to grant a right to play it. Having received the right to play (i.e., a content encryption key) from the multimedia card 260, device 210 can play the encrypted content.

After mutual authentication with the multimedia card 260 storing therein a rights object, device 250 can also request the multimedia card 260 to grant a right to play a specific content to thereby play the content. Additionally, device 250 may then receive or copy the rights object from multimedia card 260.

FIG. 4 illustrates a format of a rights object in accordance with an exemplary embodiment of the present invention.

A rights object roughly comprises a version field 300, an asset field 320, and a permission field 340.

The version field 300 identifies information about a version of the DRM system. The asset field 320 includes information about the encrypted contents whose execution is governed by the rights object. The permission field 340 includes information about actual usage or utilization associated with the encrypted content as permitted by the rights object issuer.

Of the information stored in the asset field 320, “id” information is an identifier to identify a rights object, and “uid” information is a Uniform Resource Identifier (hereinafter referred to as “URI”) of the encrypted content. The URI is information to identify the content, the usage of which is governed by the rights object.

“Inherit” information specifies the inheritance relationship between assets the usage of which is controlled by the rights object and contains information regarding a parent asset. If an inheritance relationship is present between two assets, a child asset inherits all rights of a parent asset.

“KeyValue” information stores a binary key value that is used for decryption of the encrypted content, and is referred to as a content encryption key (hereinafter referred to as a “CEK”). A CEK is a key value to decrypt the encrypted content which a device desires to use. The device can use the content with the CEK value transmitted from the multimedia card 260 storing the rights object therein.

Information stored in the permission field 340 will now be described in detail.

“Permission” is a right to use the content as permitted by the rights object issuer. By way of example, five kinds of permissions are: to play, to display, to execute, to print, and to export the content.

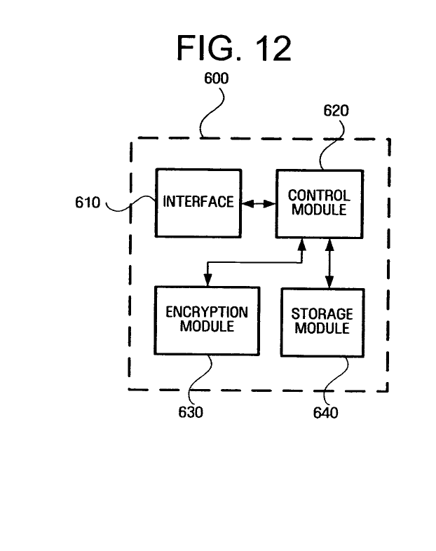

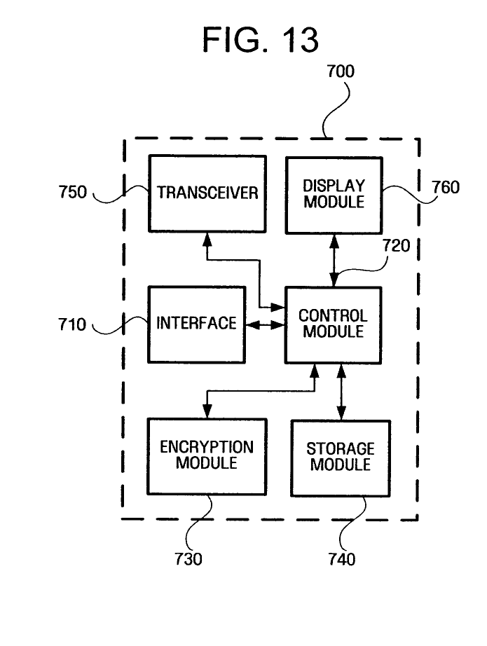

Permission to play means a right to represent the encrypted content in audio/video format. For example, if the encrypted content is associated with a movie or music, play may be set up as a permission item of a rights object to use the encrypted content. If any constraint item is defined with respect to the permission to play, a DRM agent grants a permission to play in accordance with the defined constraint. However, if no constraint is defined, the DRM agent may grant an unlimited permission to play. The DRM agent may be, for example, a control module 620 illustrated in FIG. 12 or a control module 720 illustrated in FIG. 13, to be described later respectively.

Permission to display means a right to display the encrypted content on a visual device.

Permission to execute means a right to use the encrypted content such as a Java game or other application program.

Permission to print means a right to create a hard copy of the encrypted content such as a JPEG image, etc.

The play, display, execute and print permissions described above will be collectively referred to by the term “playback.”

On the other hand, permission to export means a right to export a rights object corresponding to the encrypted content to a different DRM system or content protection structure other than the Open Mobile Alliance (OMA) DRM system.

Permission to export must have a constraint factor. The constraint factor specifies the DRM system or content protection structure with which encrypted content and a rights object can be exported. The permission to export has two modes: a move mode and a copy mode. In the move mode, the rights object within the current DRM system is deactivated when the rights object is exported to another system, but the rights object within the current DRM system remains activated in the copy mode.

FIG. 5 shows types of constraints that each of the permissions illustrated in FIG. 4 can have.

Consumption of digital content is limited by constraints that the permissions have.

Count constraint 400 has a positive integer value and specifies the number of times permission will be granted to the contents.

Datetime constraint 410 specifies the limitation of time for permission and has selective elements of start and end. When the start item is contained, consumption of the DRM content is not permitted before a specified time/date. When the end item is contained, consumption of the DRM content is not permitted after a specified time/date. Interval constraint 420 specifies the interval of time during which the right can be executed for the encrypted content, and has an element of duration. For example, consumption of the encrypted content is permitted during a specific period of time; that is, a duration after a specific time/date if there exists the start element and a duration before the specific time/date if their exists the end element.

Accumulated constraint 430 specifies the maximum interval of measured use time during which the right can be executed relative to the encrypted content. A DRM agent does not allow an access to the encrypted content after a specific accumulated interval has passed, based on an accumulated constraint value.

Individual constraint 440 specifies the individual to whom the content is bound, for example, using a uniform resource identifier (URI) of the person. Accordingly, if a device user's identity is not identical with the identity of the person permitted to use the DRM content, a DRM agent does not permit an access to the DRM content.

System constraint 450 specifies a DRM system or a contents protection structure under which the content and a rights object can be exported. A version element specifies version information of the DRM system or contents protection structure, and a uid element specifies the name of the DRM system or contents protection structure.

When a device desires to communicate with a multimedia card to move the rights object, etc., the device needs to obtain mutual authentication with the multimedia card.

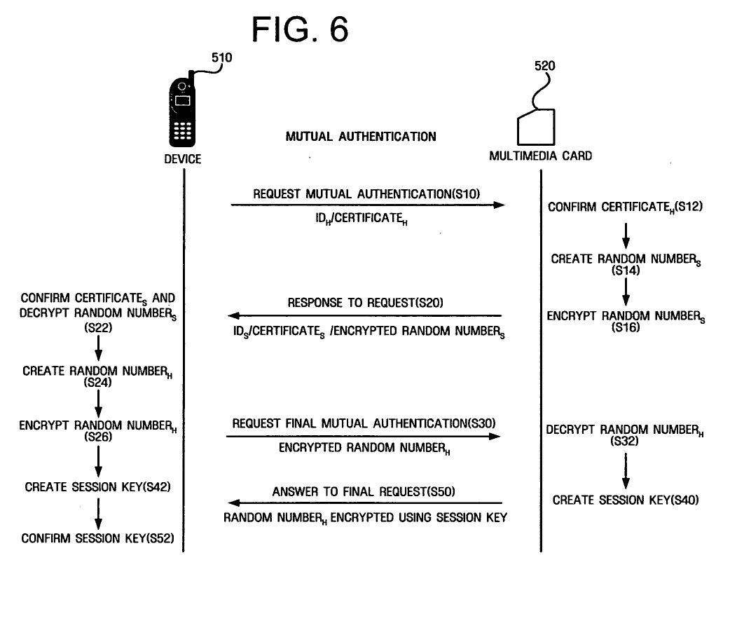

FIG. 6 shows an example of a mutual authentication process between a device and a multimedia card.

Among the subscripts used with some objects in FIG. 6, H means that the object belongs to a host (device) or is created by the device, and S means that the object belongs to a multimedia card or is created by the multimedia card.

Mutual authentication is a process in which the device 510 and the multimedia card 520 mutually confirm that they are authorized devices and exchange random numbers for creating a session key between them. The session key can be created by use of the random numbers obtained through the mutual authentication process. In FIG. 6, descriptions above the arrows depicted between the device 510 and the multimedia card 520 indicate commands to request a target device to do a certain action, and descriptions below the arrows indicate movement of a parameter or data in accordance with the command.

In accordance with an exemplary embodiment of the present invention, all the commands in the mutual authentication process are issued by the device 510 and the multimedia card 520 is requested to perform an operation according to the command.

For example, mutual authentication answer S20 may be understood as a process in which the device 510 sends a command requesting mutual authentication to the multimedia card 520, and the multimedia card 520 having received the command, sends its own ID_{S}, certificate_{S} and an encrypted random number_{S} to the device 510. Accordingly, it may be understood that the arrows between the device 510 and the multimedia card 520 indicate the moving directions of parameters or data.

In another exemplary embodiment, both the device 510 and the multimedia card 520 can issue the command. In this case, the multimedia card 520 can send the device 510 its own ID_{S}, certificate_{S} and an encrypted random number_{S} together with a commend to answer the mutual authentication in the mutual authentication answer (S20) process.

The mutual authentication process will now be described in more detail.

The device 510 and the multimedia card 520 use a pair of keys corresponding to each other when important information such as a random number is exchanged. That is, the device 510 and the multimedia card 520 respectively include a pair of keys, which consist of two corresponding keys.

In the device 510 that includes a first key and a second key, decryption may be made with the second key when encryption is made with the first key and vise versa. Any one of the two keys can be disclosed to the other devices or multimedia cards so that they can use it.

As a public key, the first key is used so as to be read by the other devices, but the other devices, except for the device 510, cannot read the second key, as a private key. In the same way, the multimedia card 520 may also include a third key and a fourth key wherein the third key is disclosed so that the other devices can read it but the fourth key can be read only by multimedia card 520.

The device 510 sends a request for mutual authentication to the multimedia card 520 (S10). Along with the request for mutual authentication, the device 510 sends the multimedia card 520 the public key (namely, the first key) of the device 510 (PuKey_{H}).

In step S10, the public key of the device 510 (PuKey_{H}) is sent through a digital certificate_{H}of the device 510 issued by a certification authority. The certificate_{H} includes the public key of the device 510 (PuKey_{H}) and a digital signature by the certification authority. The multimedia card 520 that has received the certificates_{H} can ascertain whether the device 510 is authorized, and can obtain the public key of the device 510 (PuKey_{H}) from the certificate_{H}. In this case, the device 510 may send its own device ID (ID_{H}) together with the certificate_{H}.

The multimedia card 520 judges if the term of validity of the certificates_{H} of the device 510 has expired, and confirms that the certificate_{H} is effective, using a certificate revocation list (hereinafter referred as a “CRL”) (S12). If the certificate_{H} of the device 510 is no longer effective, or it is registered in the CRL, the multimedia card 520 can reject mutual authentication with the device 510. In this case, the multimedia card 520 reports the result to the device 510, and then the device 510 stops a DRM process. If the certificate_{H} of the device 510 is not effective because of expiration or revocation, the device 510 may proceed with a process to obtain a new certificate.

Upon confirming the validity of the certificate_{H} (S12), the multimedia card 520 obtains the public key of the device 510 (PuKey_{H}) through the certificate_{H}, if the certificate_{H} is not registered in the CRL.

Thereafter, the multimedia card 520 creates a random number_{S} (S14). The created random number_{S} is encrypted with the public key of the device 510 (PuKey_{H}) (S16). When the multimedia card 520 has received a command to answer the mutual authentication by the device 510, or it has sent the command to answer the mutual authentication to the device 510, a process of answering the mutual authentication is performed (S20).

In the mutual authentication answering process, the multimedia card 520 sends its public key (the third key) (PuKey_{S}) and the encrypted random number_{S} to the device 510. In an exemplary embodiment of the present invention, the public key of the multimedia card 520 (PuKey_{S}) is sent through a certificate_{S} of the multimedia card 520 issued by the certification authority.

In another exemplary embodiment, the multimedia card 520 may send its own certificate_{S}, an encrypted random number_{S} and information on the issued date of a CRL stored in the multimedia card 520 to the device 510. This is designed to allow the device 510 and the multimedia card 520 to share the most updated CRL between them. On the other hand, the reason for sending the information on the issued date of the CRL instead of directly sending the CRL is to reduce the overhead incurred during the mutual authentication process because the CRL is not frequently updated in most cases. The issued date information of the CRL may be sent together with the random numbers or otherwise separately in encrypted format. Additionally, an ID of the multimedia card 520 (ID_{S}) can be sent simultaneously.

The device 510 receives the certificate_{S} of the multimedia card 520 and the encrypted random number_{S}, and it ascertains from the received certificate_{S} that the multimedia card 520 is an authorized device (S22). Furthermore, the device 510 having obtained the public key of the multimedia card 520 (PuKey_{S}) decrypts the encrypted random number_{S} received from the multimedia card 520 with its own private key (the second key) (PrKey_{H}), thereby obtaining the random number_{S} (S22). Based on the certificate_{S}, the device 510 can judge whether the term of validity of the certificate_{S} has expired, and whether the certificate_{S} is registered in the CRL.

Afterwards, the device 510 creates a random number_{H} (S24). Device 510 encrypts the random number_{H} using the public key of the multimedia card 520 (PuKey_{S}) (S26). A final process to request the mutual authentication is then performed. In the final process, the device 510 sends the encrypted random number_{H} to the multimedia card 520 (S30). In an exemplary embodiment of the present invention, the device 510 may send information on the issued date of the CRL stored in the device, as well as the encrypted random number_{H}, to the multimedia card 520. In this case, the information on the issued date of the CRL may be encrypted either together with or separately from the random number_{H}.

The multimedia card 520 receives the encrypted random number_{H} and decrypts it with its own private key (the fourth key) (S32). Accordingly, the device 510 and the multimedia card 520 can share the random numbers created by themselves and the random numbers created by their counterparts, thereby generating a session key using the co-shared two random numbers (random number_{H} and random number_{S}) (S40 and S42). In the present embodiment, both the device 510 and the multimedia card 520 create random numbers that are then used to create the session key, whereby the overall randomness is greatly increased, thereby making the mutual authentication more secure. That is, even if either party has a weak randomness, the other party can supplement the weak randomness.

Through these processes, the device 510 and the multimedia card 520 can authenticate each other and share an identical session key. On the other hand, each party is required to confirm that its session key is the same as a session key of its counterpart. The confirmation can be made during the final mutual authentication answering process S50. That is, one party encrypts information that is readable by the other party with its own session key and then sends the encrypted information to the other party. If the other party can decrypt the received information with its own session key, it can confirm that the session keys are equal to each other.

In an exemplary embodiment, the multimedia card 520 encrypts a random number_{H}, created by the device 510, with its session key and then sends the encrypted random number_{H} to the device 510 (S50). In this case, the device 510 can confirm whether its session key is the same as that of the multimedia card 520 by confirming whether the random number_{H}, encrypted with the session key of the multimedia card 520, can be decrypted with its own session key (S52).

In another exemplary embodiment, after a predetermined period of time has passed since the final process to request the mutual authentication in step S30, the device 510 encrypts the random number_{S}, created by the multimedia card 520, with its own session key, and then sends the encrypted random number_{S} to the multimedia card 520. In this case, the multimedia card 520 decrypts the encrypted random number_{S} with its own session key to confirm whether its session key is the same as that of the device 510.

If the session keys are not identical, mutual authentication can be attempted again from the first step. In another exemplary embodiment, if the session keys are not the same, the DRM process between the device 510 and the multimedia card 520 may be terminated.

In the present embodiment, a random number may be created through a random number multimedia card or a random number creating module (not shown), and it may be a single random number or a combination of multiple random numbers selected from among a plurality of random numbers which have been previously created and stored in the device or the multimedia card. Further, the random number may indicate merely a number or a string including letters in addition to number. Accordingly, the random number used in the present specification can be interpreted to include a single number or a combination of numbers created through the random number creating module, or a string. Further, it may be interpreted to include a single number or a string, or a combination of multiple numbers or strings selected from among stored numbers or strings.

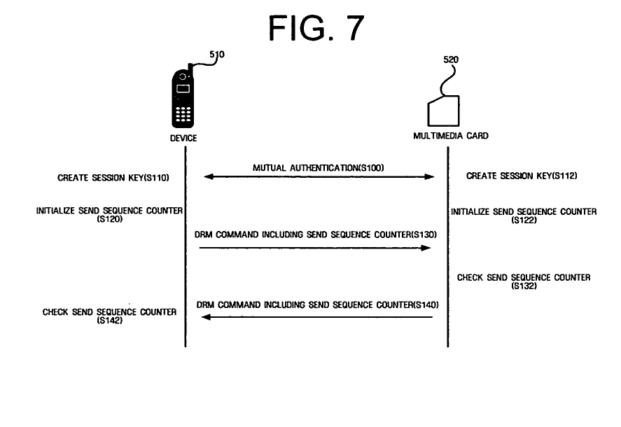

In exemplary embodiments of the present invention, securer DRM is made possible by using two random numbers in the mutual authentication process between the device 510 and the multimedia card 520 In addition, it can be judged whether the mutual authentication process has been correctly performed, through a process to confirm a session key. According to exemplary embodiments of the present invention, a secure DRM operation between the device 510 and the secure multimedia card 520 is made possible by means of a session key created in the mutual authentication process, but a process to confirm a send sequence may be added after the mutual authentication process so as to make securer DRM operation possible. This process will be described with reference to FIG. 7.

FIG. 7 shows a DRM process to which a send sequence counter is applied in accordance with an exemplary embodiment of the present invention.

In the DRM process, diverse operations are available between the device 510 and the multimedia card 520. That is, there may be DRM for a rights object such as Move, Copy or Delete of the rights object, or DRM for content such as Playback. The DRM processes are subject to the mutual authentication between the device 510 and the multimedia card 520. In other words, the DRM processes can only be formed when the mutual authentication between the device 510 and the multimedia card 520 has been completed (S100). As a result of the mutual authentication, the device 510 and the multimedia card 520 mutually create identical session keys (S110 and S112). The DRM processes can be performed only after the session keys are shared between the device 510 and the multimedia card 520. For securer DRM, a send sequence counter (SSC) can be used. The send sequence counter is included in an Application Protocol Data Unit (APDU), and is incremented each time an APDU is sent. For example, if one or more APDUs are intercepted by an intruder in the middle of the sequence of APDUs, discontinuity occurs in the send sequence counter included in the received APDUs. Further, even where an intruder inserts an APDU, there occurs discontinuity in the send sequence counter included in the received APDUs.

The device 510 and the multimedia card 520 each initialize their own send sequence counter for the DRM process after the mutual authentication (S120 and S122). In an exemplary embodiment, the send sequence counter is initialized with a number combining the random number_{H} and the random number_{S} generated during the mutual authentication process. For example, when the send sequence counter has a size totaling 2 bytes, the send sequence counter is initially set to a combination of the last 1 byte of the random number_{H} and the last 1 byte of the random number_{S}. At this time, if the last 1 byte of the random number_{H} is “01010101” and the last 1 byte of the random number_{S} is “11111110,” the send sequence counter is initialized with “0101010111111110.” Randomness can be increased by setting an initial value of the send sequence counter by means of the random number_{H} and the random number_{S} instead of initializing it with 0000000000000000, whereby a securer DRM process is made possible.

When the device 510 sends a DRM command to the multimedia card 520, a value of its send sequence counter is included in the APDU (S130). If a total of 10 APDUs are transmitted with the DRM command, the send sequence counter will be incremented by 1 per APDU, starting from its initial value of 0101010111111110. The multimedia card 520 can then check the send sequence counter value and judge whether any undue APDU is inserted therein, or any original APDU is intercepted and removed therefrom (S132).

Likewise, when the multimedia card 520 sends a DRM command to the device 510, a value of its send sequence counter is included in the APDU (S140). In an exemplary embodiment, the initial value originally initialized is used as the initial value of the send sequence counter. For example, if a total of 10 APDs are transmitted, the send sequence counter will be incremented by 1 per each APDU starting from the initial value of 0101010111111110. In another exemplary embodiment, the initial value of the send sequence counter will be based on a value of the send sequence counter finally sent. For example, when the final send sequence counter value is 1000000000000000, the send sequence counter value inserted in the next APDU starts from 1000000000000001. The device 510 can then check the send sequence counter value and judge whether any undue APDU is inserted therein, or any original APDU is intercepted and removed therefrom (S142).

Sequential incrementing of the send sequence counter is described by way of example, but incrementing or decrementing of the send sequence counter by much or less than 1 are also covered in the technical concept of the present invention.

In the mutual authentication process explained through FIG. 6, the step wherein the device 510 or the multimedia card 520 judges whether the certificate of its counterpart is included in the CRL stored therein is important so as to confirm whether the counterpart is authorized. Accordingly, the validity of the counterpart's certificate can be confirmed by the device 510 or the multimedia card 520 through the mutual authentication and even after the mutual authentication. Therefore, where the counterpart's certificate is effective, the mutual exchange of data in a continued manner is desirable. Thus, the device 510 and the multimedia card 520 require a CRL by which it can be confirmed whether the counterpart's certificate is effective. Also, it is desirable for the CRL to be updated with a CRL having the most recent issued date.

Hereinafter, a process to update the CRL will be described in accordance with an exemplary embodiment of the present invention.

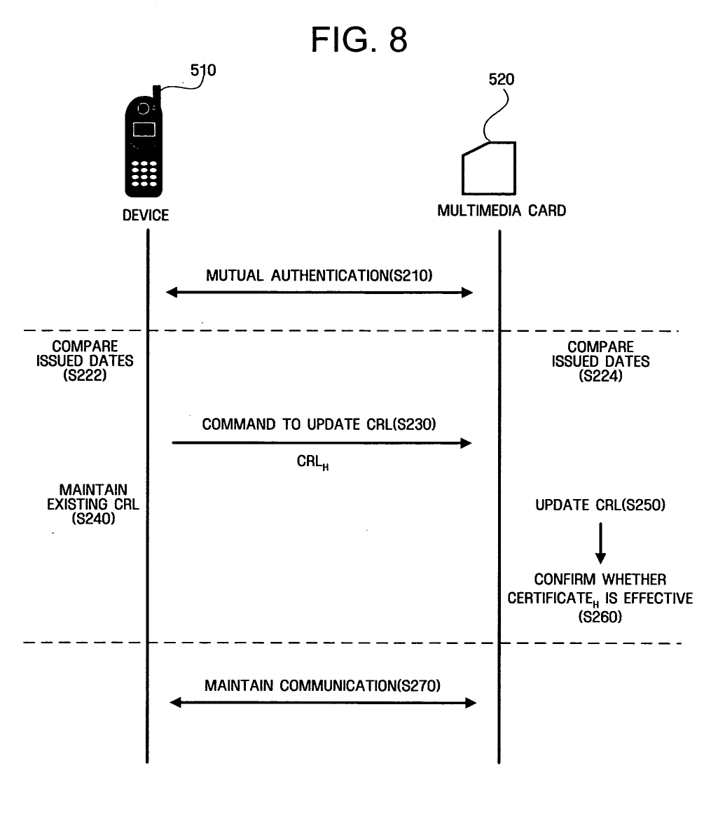

FIG. 8 shows the CRL updating process between the device and the multimedia card in accordance with an exemplary embodiment of the present invention.

When mutual authentication is completed between the device 510 and the multimedia card 520 (S210), the device 510 compares the issued date information of the CRL stored therein with the issued date information of the CRL stored in the multimedia card 520 (S222). The device 510 obtains the issued date information of the CRL of the multimedia card 520 in the mutual authentication process described above.

In the meantime, the multimedia card 520 also compares the issued date of the CRL stored therein with the issued date of the CRL of the device 510 (S224). The multimedia card 520 obtains the issued date information of the CRL of the device 510 in the mutual authentication process described above.

As a result of the aforementioned comparisons, if the issued date of the CRL of the device 510 is more recent than the issued date of the CRL of the multimedia card 520, the device 510 may transmit its own CRL together with a command to update the CRL to the multimedia card 520 (S230). At this time, the device 510, to reinforce the security of communication, may incorporate the CRL to be transmitted with an SSC value that was explained in FIG. 5, encrypt it with a session key, and send it to the multimedia card 520.

The device 510 can maintain its own CRL (S240), while the multimedia card 520 updates its own CRL with the more recent CRL received from the device 510 (S250). The update may be an update to revoke its own CRL and replace it with the CRL received from the device 510 as a new CRL.

Thereafter, the multimedia card 520, based on the updated CRL, can judge whether the certificate_{H} of the device 510 is valid (S260). If the validity of mutual certificates has not been confirmed in the mutual authentication process, there may be added a process for the device 510 to judge the validity of the certificate_{S} of the multimedia card 520, based on its own CRL.

Where the certificate_{H} of the device 510 is judged as valid through the updated CRL, the multimedia card 520 can maintain communication with the device 510 (S270). On the contrary, where the certificates_{H} of the device 510 is judged as having been revoked, the multimedia card 520 may terminate the communication with the device 510.

Furthermore, the multimedia card 520 can terminate the communication with the device 510, if the multimedia card 520 has not received a command to update the CRL from the device 510 or acquired the CRL of the device 510 although it was judged from the result of comparing the issued dates in step S224 that the issued date of the CRL of the device 510 is more recent than the issued date of the CRL of the multimedia card 520.

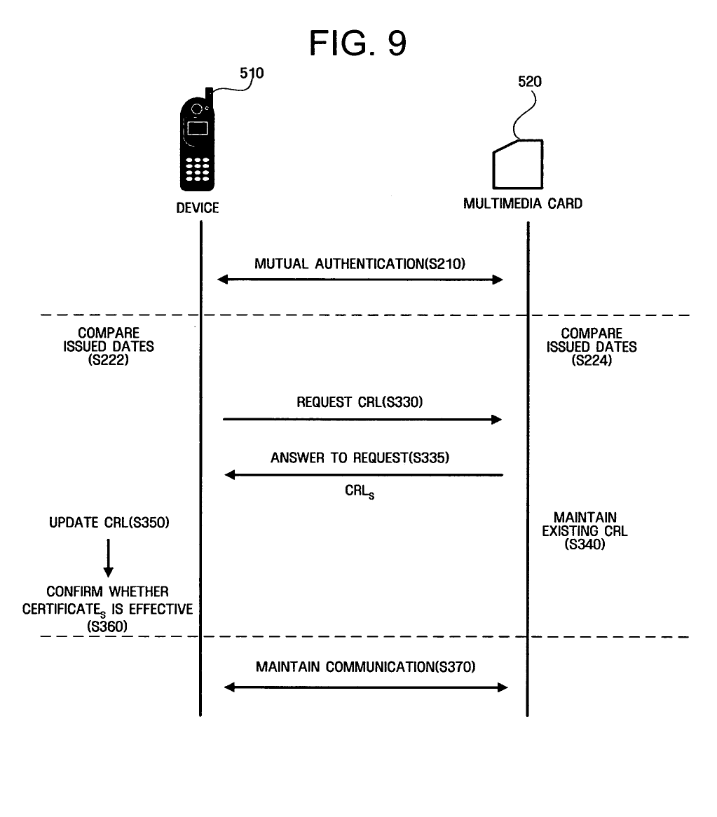

An exemplary embodiment wherein it is determined that the issued date of the CRL stored in the multimedia card 520 is more recent than that stored in the device 510, from comparing the issued dates in steps S1 22 and S124, is illustrated in FIG. 9.

Steps S210, S222 and S224 in FIG. 9 can be performed in the same manner as the steps S210, S222 and S224 in FIG. 8. If it is determined that the issued date of the CRL stored in the multimedia card 520 is more recent than the issued date of the CRL stored in the device 510, in steps S222 and S224, the device 510 can request the multimedia card 520 send its CRL to the device 510 (S330).

Upon receiving the request, the multimedia card 520 may transmit its own CRL stored therein to the device 510 (S335). In this case, the multimedia card 520, to reinforce the security of communication, can encrypt the CRL to be transmitted with a session key after incorporating it with an SSC value as explained through FIG. 5 and then send the encrypted CRL to the device 510. As another exemplary embodiment, the multimedia card 520 that received the CRL request from the device 510 may also permit the device 510 to access its own CRL stored therein.

The multimedia card 520 can maintain its own CRL (S340), while the device 510 can update its own CRL with the CRL of the multimedia card 520 (S350). The update may be an update to revoke its own CRL and to substitute it with a new CRL obtained from the multimedia card 520.

Thereafter, the device 510 can judge the effectiveness of the certificate_{S} of the multimedia card 520 based on the updated CRL (S360). If the effectiveness of mutual certificates is not judged in the mutual authentication process, there may be added a process for the multimedia card 520 to judge the effectiveness of the certificate_{H} of the device 510, based on its own CRL.

When the certificate_{S} of the multimedia card 520 is judged as effective through the updated CRL, the device 510 can maintain communication with the multimedia card 520 (S370). When the certificate_{S} of multimedia card 520 is judged as revoked through the updated CRL, the device 510 can terminate communication with the multimedia card 520.

Furthermore, where the device 510 has neither received the CRL from multimedia card 520 nor been able to access the CRL of the multimedia card 520, although the device 510 requested the CRL from the multimedia card 520 (S330), the device 510 can terminate communication with the multimedia card 520.

In FIGS. 8 and 9, when it is determined that the issued date of the CRL version of the device 510 and that of the multimedia card 520 are the same (S222 and S224), the device 510 and the multimedia card 520 can respectively maintain their own CRLs as they are.

The CRL of the multimedia card 520 may be stored in the multimedia card 520 at the time of production of the multimedia card 520, or may be obtained from another existing device or system.

As another exemplary embodiment of the present invention, the device 510 or the multimedia card 520 may perform a process to compare the issued date of its own CRL with the issued date of the CRL of its counterpart, wherein the device 510 or the multimedia card 520 updates its own CRL with the CRL having the more recent issued date, even in the mutual authentication process.

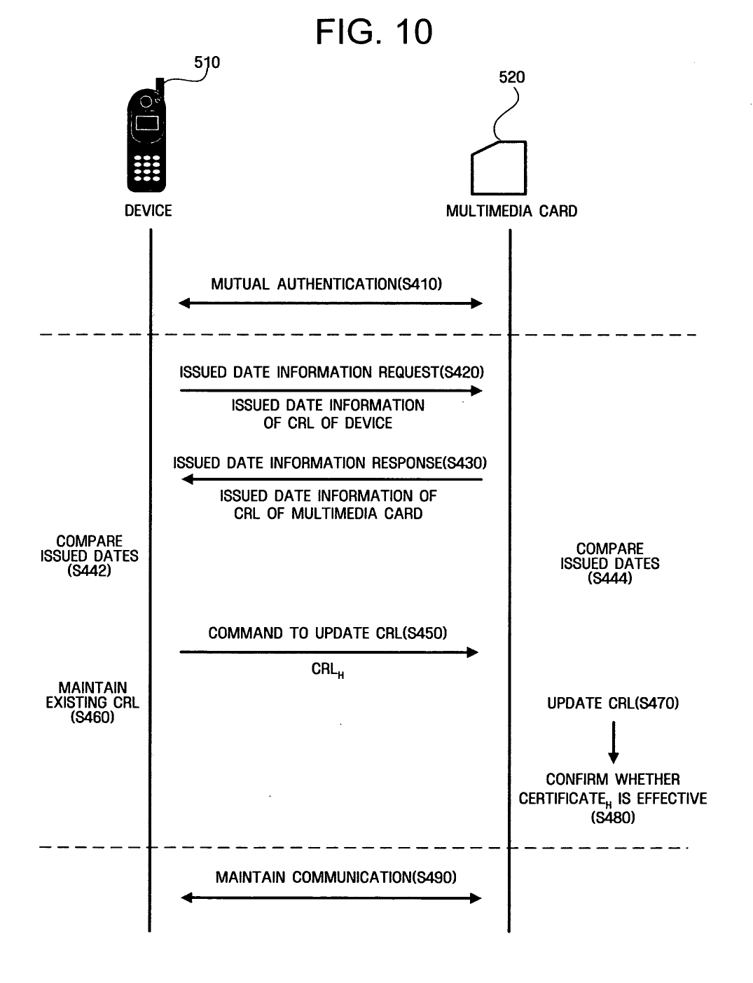

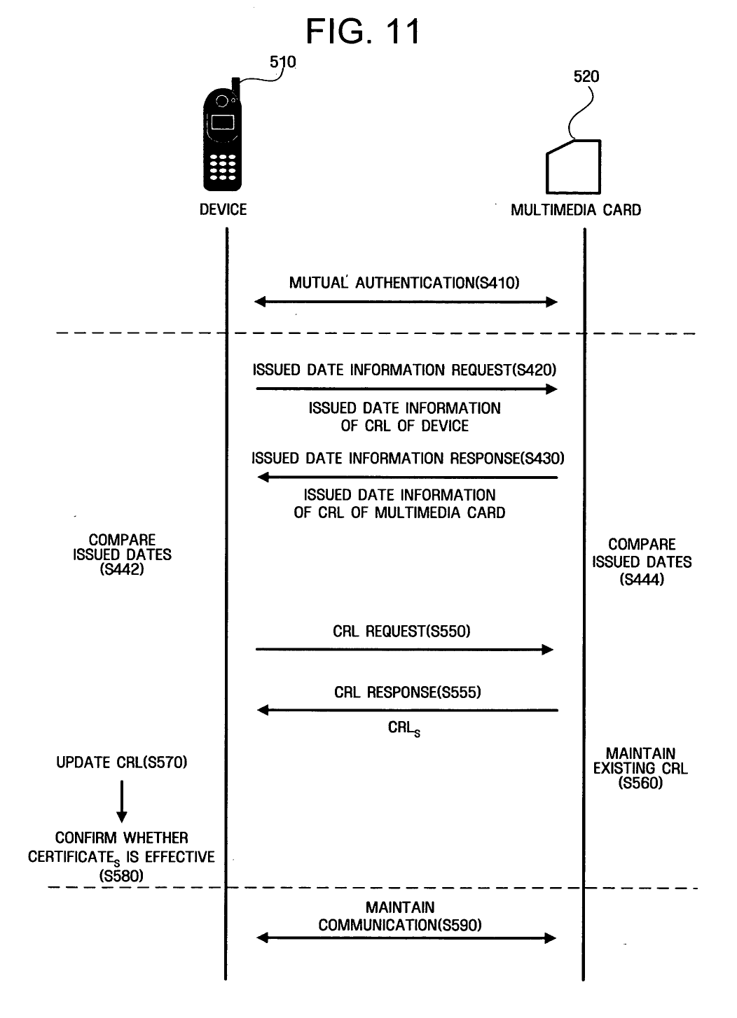

As still another exemplary embodiment of the present invention, where information regarding the issued dates of the CRLs stored in the device 510 and the multimedia card 520, respectively, in the mutual authentication process is not exchanged between the device 510 and the multimedia card 520, the CRL updating process between the device 510 and the multimedia card 520 will be described with reference to FIGS. 10 and 11.

FIG. 10 shows a CRL updating process between a device and a multimedia card in accordance with another exemplary embodiment of the present invention.

The device 510 and the multimedia card 520 perform a mutual authentication(S410). Session keys are created by the device 510 and the multimedia card 520 after the mutual authentication has been completed. In this respect, the device 510 and the multimedia card 520 can encrypt data to be sent to their counterpart with their session key, receive encrypted data from their counterpart and then decrypt the encrypted data with their session key. In the present embodiment and the exemplary embodiment described with reference to FIG. 11, the device 510 and the multimedia card 520 may incorporate an SSC value described above through FIG. 7 with data to be sent to their counterpart, encrypt the SCC value and data with their session key and then send the encrypted SCC value and data so as to reinforce the security of the communication.

Since information regarding the issued dates of the CRLs of the device 510 and the multimedia card 520 is not exchanged between the device 510 and the multimedia card 520, it is necessary for the device 510 and the multimedia card 520 to perform a process to obtain the information regarding the issued date of the CRL of their counterpart, in order to update their own CRLs as necessary.

Thus, the device 510 requests the multimedia card 520 to send information on the issued date of the CRL of the multimedia card 520 to the device 510 (S420). At this time, the device 510 can transmit information on the issued date of its own CRL to the multimedia card 520.

In response to the request, the multimedia card 520 transmits information on the issued date regarding its CRL to the device 510 (S430). As another exemplary embodiment, the multimedia card 520 that has received the request for the information on the issued date regarding its CRL from the device 510 can permit the device 510 to access its CRL stored therein to obtain the information on the issued date of its CRL.

The device 510 and the multimedia card 520, each having received the information on the issued date information of the CRL of their counterpart, then compare the issued date of the CRL of their counterpart with the issued date of their own CRL (S442 and S444).

If the issued date comparison result shows that the the issued date of the CRL of the device 510 is more recent than the issued date of the CRL of the multimedia card 520, the device 510 can send the multimedia card 520 its own CRL together with a command to update the CRL of the multimedia card (S450).

The multimedia card 520 can update its own CRL with the received CRL_{H} (S470). This update may involve revoking its own CRL and replacing it with the CRL received from the device 510 as a new CRL. Further, the device 510 can maintain its own CRL as it is (S460).

Thereafter, the multimedia card 520 can judge whether the device certificates_{H} is effective, based on the updated CRL (S480). If it was not determined in the mutual authentication process whether each of the certificate_{S} are effective, a process for the device 510 to judge the effectiveness of the multimedia card certificate_{S} based on its own CRL may also be added.

Through the updated CRL, if the device certificates_{H} is judged as effective, the multimedia card 520 can maintain communication with the device 510 (S490). Conversely, if it is judged through the updated CRL that the device certificates_{H} is revoked, the multimedia card 520 can terminate communication with the device 510.

Furthermore, the multimedia card 520 can terminate communication with the device 510 when it has not received the CRL updating command from the device 510 or the CRL_{H} from the device 510, although it is determined from comparing the issued dates (S444) that the issued date of the CRL of the device is more recent than the issued date of the CRL of the multimedia card 520.

FIG. 11 illustrates a case where comparison of the issued dates as described above (S442 and S444) confirms that the issued date information of the CRL of the multimedia card 520 is more recent than the issued date of the CRL of the device 510.

In FIG. 11, steps S410, S420, S430, S442 and S444 are performed in the same way as steps S410, S420, S430, S442 and S444 illustrated in FIG. 10.

From the comparison of the issued dates (S442 and S444), if it is determined that the issued date of the CRL of the multimedia card 520 is more recent than the issued date of the CRL of the device 510, the device 510 can request the multimedia card 520 to send it the CRL of the multimedia card 520 stored therein (S550).

Upon request, the multimedia card 520 can send its own CRL_{S} to the device 510 (S555). As another exemplary embodiment, the multimedia card 520 that has received the CRL request from the device 510 can permit the device 510 to access its own CRL stored therein.

The multimedia card 520 can maintain its own CRL as it is (S560). In this case, the device 510 can update its own CRL with the CRL_{S} (S570). This update may involve revoking its own CRL and replacing it with the CRL received from the multimedia card 520 as a new CRL.

Thereafter, the device 510 can judge the effectiveness of the multimedia card certificate_{S} based on the updated CRL (S580). If the effectiveness of each of the certificate_{S} was not judged in the mutual authentication process, a process for the multimedia card 520 to judge the effectiveness of the device certificates_{H} based on its own CRL may also be added.

If the multimedia card certificate_{S} is also judged as effective through the updated CRL, the device 510 can maintain communication with the multimedia card 520 (S590). However, if the multimedia card certificate is determined to be revoked through the updated CRL, the device 510 can terminate communication with the multimedia card 520.

Furthermore, if the device 510 has neither received the CRL of the multimedia card 520 nor been able to access the CRL of the multimedia card 520, although it requested the CRL from the multimedia card 520 (S550), the device 510 can terminate communication with the multimedia card 520.

As another embodiment of the present invention, the CRL updating process between the device 510 and the multimedia card 520 can be performed even during the mutual authentication.

Although the CRL updating was performed before or during the mutual authentication between the device 510 and the multimedia card 520, where the device and the multimedia card have been connected for a long time with a single mutual authentication, it is desirable to terminate communication between the device and the multimedia card if either the certificate_{H} of the device 510 or the certificate_{S} of the multimedia card 520 was revoked within that period. Accordingly, when the device 510 receives a newly issued CRL while connected with the multimedia card 520, the device 510 can send the newly issued CRL to the multimedia card 520 so that the multimedia card 520 can re-update its CRL. Thus, using the re-updated CRL, the device 510 and the multimedia card 520 can reconfirm the effectiveness of the counterpart's certificate. If the CRL is not stored in the multimedia card 520, the time for the next update of the stored CRL arrives, or a certificate validity term of the multimedia card 520 or the device 510 expires, the multimedia card can obtain a new CRL or certificate through the device from the certification authority and the like.

However, if the new CRL or certificate cannot be obtained, the multimedia card can terminate communication with the device.

In all of the above-mentioned embodiments, it is preferable, but not necessary, for all the data information transmitted between the multimedia card 520 and the device 510 to be encrypted prior to transmission. The multimedia card 520 and the device 510 can perform encryption/decryption using a public key and a private key based on the public key encryption method before the multimedia card and the device complete the mutual authentication, and also perform encryption/decryption using the session key, created as a result of the mutual authentication, after mutual authentication is completed.

FIG. 12 is a block diagram showing a portable storage available for DRM in accordance with an exemplary embodiment of the present invention.

Modules used in the present embodiment and the following embodiment include software or hardware elements, such as a field-programmable gate array (FPGA) or an application-specific integrated circuit (ASIC), to perform a specific function. Modules, however, are not defined as software or hardware. Modules may be configured in a addressable storage medium, or configured to reproduce one or more processors.

Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute in one or more computers in a communication system.

In order to perform the DRM process, the portable storage 600 needs to have a security function; a storage function for storing content, a rights object, its own certificate, a CRL, etc.; a function to exchange data with a device; and a DRM management function. Here, the multimedia card 600 is provided with an encryption module 630 having a security function, a storage module 640 having a storage function, an interface 610 enabling data exchange with a device, and a control module 620 controlling each module in order to perform the DRM process.

The interface 610 functions so that the portable storage 600 can be connected with the device.

Connection of a portable storage to a device includes, for example, an electrical interconnection between the interfaces of the device and the portable storage. Herein, the term “connection” would also include the portable storage and the device being in a state that mutual communication is available through a wireless medium while there is no physical connection.

The encryption module 630, as a module for encryption, encrypts the data transmitted to the device at the request of the control module 620, or decrypts the encrypted data received from the device. The encryption module 630 can perform at least one of a secret key encryption method and a public key encryption method; and, there may exist one or more encryption modules to perform both encryption methods.

Specifically, rights objects are stored in an encrypted form, and the portable storage 600 can encrypt the rights objects through the encryption module 630, using a distinct encryption key that cannot be read from other devices. Furthermore, when moving or copying a rights object to another device, or when the other device requests permission to use specific content, the encrypted rights object can be decrypted using the distinct encryption key. The rights object can be encrypted by use of a symmetric key encryption method using the distinct encryption key. Furthermore, it is also possible to encrypt the rights object with a private key of the portable storage 600 and to decrypt it with a public key of the portable storage 600 as necessary.

The storage module 640 stores, for example, encrypted content, a rights object, a certificate and CRL of the portable storage 600, etc. The CRL of the portable storage 600 may be a CRL stored in the storage module 640 when the portable storage 600 was produced, or may have been updated or stored through a CRL updating process of the portable storage 600 with the other devices.

When the portable storage 600 is connected to a device, the control module 620 may control a mutual authentication process with the device.

Further, the control module 620 may obtain the device certificate from the device connected with the portable storage 600 and compare it with the CRL stored in the storage module 640, thereby judging whether the device certificate is revoked. If the device certificate is judged as revoked, the control module 620 may terminate communication with the device.

Preferably, but not necessarily, the CRL of the portable storage 600 issued recently. To ensure such, the control module 620 may obtain the issued date of the CRL of the device from the device and compare it with the issued date of the CRL stored in the storage module 640. A process to obtain the issued date information of the CRL of the device may be performed during or after the mutual authentication process as described above.

If the issued date comparison result shows that the issued date of the CRL of the device is more recent than the issued date of the CRL stored in the storage module 640, the control module 620 may terminate communication with the device until the CRL of the device is received by the portable storage 600. When the CRL is received from the device, the control module 620 may update the CRL stored in storage module 640 as the CRL of the device. Such updating may involve revoking the existing CRL stored in the storage module 640 and storing the new CRL received from the device in the storage module 640. After updating the CRL, the control module 620 may judge whether the device certificate is revoked through the updated CRL. If the device certificate is not revoked, communication with the device can be maintained.

On the other hand, if the issued date comparison result shows that the issued date of the CRL of the device is not more recent than the issued date of the CRL stored in the storage module 640, the control module 620 may transmit the CRL stored in the storage module 640 to the device.

The control module 620 may terminate communication with a device until a certificate is re-issued or the CRL is updated if the validity term the certificate stored in the storage module 640 expires or a time for the next update of the CRL arrives.

The control module 620 may include the SSC value explained through FIG. 7 in each APDU that is transmitted. For each APDU that is received, the control module 620 obtains the SSC value from the received APDU and compares it with its own counted SSC value, thereby reinforcing the security in the communication with the device. As another exemplary embodiment of the present invention, the portable storage 600 may be provided with a separate module to check the security through the SSC value, the content of the SSC value having been explained in detail through FIG. 7.

FIG. 13 is a block diagram that shows a construction of a device available for DRM in accordance with an exemplary embodiment of the present invention.

In order to perform the DRM, a device 700 needs to have a security function; a function to store content, a rights object, its own certificate and CRL, etc.; a function to exchange data with a multimedia card; a function to send and receive data through communication with a content provider, a rights issuer, etc.; and a DRM function. Thus, the device 700 is provided with an encryption module 730 having a security function, a storage module 740 having a storage function, an interface 710 enabling data exchange with the portable storage, and a control module 720 controlling each module to perform the DRM. Further, the device 700 may provided with a transceiver module 750 for sending/receiving data and a display module 760 for displaying the content, for example, in response to a Play or Execute operation.

The transceiver module 750 enables the device 700 to communicate with the content provider or the rights issuer in a wired or wireless manner. The device 700 may obtain a rights object or encrypted content from an external source through the transceiver module 750, and also a certificate or a CRL through communication with a certification authority.

The interface 710 enables the device 700 to be connected with a portable storage. By way of example, connection of the device 700 to the portable storage implies that the interfaces of the portable storage and the device are electrically connected. The “connection,” however, should also be interpreted to encompass the device 700 and the portable storage being in communication through a wireless medium without physical contact.

The encryption module 730, as a module performing encryption, encrypts the data transmitted to the portable storage at the request of the control module 720 or decrypts the encrypted data received from the portable storage. The encryption module 730 may employ a secret key encryption method as well as a public key encryption method. In this respect, there may exist two or more encryption modules to perform both methods.

Specifically, rights objects are stored in an encrypted form, and the device 700 can encrypt the rights objects through the encryption module 730, using a distinct encryption key that cannot be read from other devices or the portable storage. To move or copy a rights object to another device or the portable storage, the device 700 may decrypt it using the distinct encryption key. For encryption of the rights object, a symmetric key encryption method using a distinct encryption key may be used. Furthermore, it is possible to encrypt the rights object with a private key of the device 700 and to decrypt it with a public key of the device 700 as necessary.

The storage module 740 stores encrypted content, a rights object and a certificate and CRL of the device 700.

The control module 720 can control the mutual authentication process with portable storage when the device 700 is connected to the portable storage. Furthermore, the control module 720 can obtain the portable storage certificate from the portable storage connected with the device 700 and compare it with the CRL stored in the storage module (740), thereby judging whether the portable storage certificate is revoked. If the portable storage certificate is judged as revoked, the control module 720 may terminate communication with the portable storage.

Preferably, but not necessarily, the CRL of the device 700 issued recently. To ensure such, the control module 720 may obtain the issued date of the CRL of the portable storage from the portable storage and compare it with the issued date of the CRL stored in the storage module 740. A process to obtain the issued date of the CRL of the portable storage can be performed during or after the mutual authentication process as described above.

If the issued date comparison result shows that the issued date of the CRL of the portable storage is more recent than the issued date of the CRL stored in the storage module 740, the control module 720 requests a CRL of the portable storage. In this case, the control module 720 may terminate communication with the portable storage until the CRL is received from the portable storage.

When the CRL is received from the portable storage, the control module 720 can update the CRL stored in the storage module 740 as the CRL of the portable storage. Such updating may involve revoking the existing CRL stored in the storage module 740 and storing the new CRL received from the portable storage in the storage module 740. After updating the CRL, the control module 720 can judge whether the portable storage certificate is revoked through the updated CRL. If the portable storage certificate is judged as not revoked, communication with the portable storage can be maintained.

On the other hand, if the issued date comparison result shows that the issued date of the CRL of the portable storage is not more recent than the issued date of the CRL stored in the storage module 740, the control module 720 may transmit the CRL stored in the storage module 740 to the portable storage.

The control module 720 may terminate communication with a portable storage until a certificate is re-issued or the CRL is updated if the validity term of the certificate stored in the storage module 740 expires or a time for the next update of the CRL arrives.

Furthermore, the control module 720 may include a SSC value explained through FIG. 7 in each APDU that is transmitted. For each APDU that is received, the control module 720 obtains the SSC value from the received APDU and compares it with its own counted SSC value, thereby reinforcing the security in the communication with the portable storage.

As another exemplary embodiment of the present invention, the device 700 may be provided with a separate module to check the security through the SSC value, the content of the SSC value having been explained in detail through FIG. 7.

The display module 760 displays the content whose use is authorized through a rights object so that a user can visually see it as used (for example, through playing or executing the content, etc.). The display module 760 may be constructed with a liquid crystal display such as a TFT LCD or an organic EL.

In each exemplary embodiment as described above, a device and a portable storage judge whose CRL more recently issued by exchanging information on the issued date of their respective CRL, by way of example. According to another exemplary embodiment of the present invention, a device and a portable storage may exchange CRL version information and compare its own CRL version with that of its counterpart, thereby judging whose CRL more recently issued.

The method and device for digital rights management according to the present invention are advantageous in that the security of the DRM applied to a device and a portable storage is reinforced through an updated certificate revocation list.

The exemplary embodiments of the present invention have been described with reference to the accompanying drawings. However, those skilled in the art will appreciate that many variations and modifications can be made to the disclosed embodiments without substantially departing from the principles of the present invention. Therefore, the disclosed embodiments of the invention are used in a generic and descriptive sense only and not for purposes of limitation.

1. A method for digital rights management using a certificate revocation list (CRL), which is performed by a device, the method comprising:
updating a CRL of the device through a connection of the device to a portable storage to generate an updated CRL of the device;
judging whether a certificate of the portable storage is effective using the updated CRL of the device; and
maintaining communication between the device and the portable storage if it is judged that the certificate of the portable storage is effective.

2. The method of claim 1, wherein updating of the CRL of the device comprises:
obtaining issued date information of a CRL of the portable storage;
comparing the issued date information of the CRL of the portable storage with issued date information of the CRL of the device;
obtaining the CRL of the portable storage and replacing the CRL of the device with the CRL of the portable storage if the issued date of the CRL of the portable storage is more recent than the issued date of the CRL of the device; and
maintaining the CRL of the device if the issued date of the CRL of the portable storage is not more recent than the issued date of the CRL of the device.

3. The method of claim 2, wherein obtaining the issued date information of the CRL of the portable storage is performed after the device has completed mutual authentication with the portable storage.

4. The method of claim 3, wherein an application protocol data unit sent between the device and the portable storage is encrypted together with a send sequence counter value which indicates a send sequence count of the application protocol data unit and the data therein.

5. The method of claim 1, wherein if an interval before a next update of the updated CRL is due expires, the method further comprises:
receiving a most recent CRL from one of an external system and an external device;
updating the CRL of the device with the most recent CRL;
judging whether the certificate of the portable storage is effective using the most recent CRL; and
maintaining communication between the device and the portable storage if it is judged that the certificate of the portable storage is effective.

6. A method for digital rights management using a certificate revocation list (CRL), which is performed by a portable storage, the method comprising:
updating a CRL of the portable storage through a connection of the portable storage to a device to generate an updated CRL of the portable storage;
judging whether a certificate of the device is effective using the updated CRL of the portable storage; and
maintaining communication between the portable storage and the device if it is judged that the certificate of the device is effective.

7. The method of claim 6, wherein updating of the CRL of the portable storage comprises:
obtaining issued date information of a CRL of the device;
comparing the issued date information of the CRL of the device with issued date information of the CRL of the portable storage;
obtaining the CRL of the device and replacing the CRL of the portable storage with the CRL of the device if the issued date of the CRL of the device is more recent than the issued date of the CRL of the portable storage; and
maintaining the CRL of the portable storage if the issued date of the CRL of the device is not more recent than the issued date of the CRL of the portable storage.

8. The method of claim 7, wherein obtaining the issued date information of the CRL of the device is performed after the portable storage has completed mutual authentication with the device.

9. The method of claim 8, wherein an application protocol data unit sent between the device and the portable storage is encrypted together with a send sequence counter value which indicates a send sequence count of the application protocol data unit and the data therein.

10. The method of claim 7, wherein the CRL of the portable storage is stored when the portable storage is manufactured.

11. The method of claim 7, wherein the CRL of the portable storage is updated through a connection of the portable storage to another device or system.

12. The method of claim 6, wherein if an interval before a next update of the updated CRL is due expires, the method further comprises:
receiving a most recent CRL from one of an external system and an external device;
updating the CRL of the portable storage with the most recent CRL;
judging whether the certificate of the device is effective using the most recent CRL; and
maintaining communication between the portable storage and the device if it is judged that the certificate of the device is effective.

13. A storage medium with a computer readable program recorded thereon for performing a method comprising:
updating a CRL of a device through a connection of the device to a portable storage to generate an updated CRL of the device;
judging whether a certificate of the portable storage is effective using the updated CRL of the device; and
maintaining communication between the device and the portable storage if it is judged that the certificate of the portable storage is effective.

14. A storage medium with a computer readable program recorded thereon for performing a method comprising:
updating a CRL of a portable storage through a connection of the portable storage to a device to generate an updated CRL of the portable storage;
judging whether a certificate of the device is effective using the updated CRL of the portable storage; and
maintaining communication between the portable storage and the device if it is judged that the certificate of the device is effective.

15. A device for digital rights management, comprising:
an interface that connects the device to a portable storage;
a storage module that stores a first certificate revocation list (CRL); and
a control module that compares issued date information of a second CRL received from the portable storage connected through the interface with issued date of the first CRL stored in the storage module and that updates the first CRL based on the comparison.

16. The device of claim 15, wherein updating the first CRL comprises:
receiving the second CRL from the portable storage;
replacing the first CRL with the second CRL if an issued date of the second CRL is more recent than an issued date of the first CRL; and
maintaining the first CRL in the storage module if the issued date of the second CRL is not more recent than the issued date of the first CRL.

17. The device of claim 16, wherein the control module receives a certificate of the portable storage through the interface and maintains communication between the device and the portable storage if the received certificate of the portable storage is not included in the updated CRL.

18. The device of claim 17, wherein, when if an interval before a next update of the updated CRL is due expires, the control module terminates communication between the device and the portable storage until the CRL stored in the storage module is re-updated.

19. The device of claim 18, wherein once the CRL in the storage module is re-updated, the control module resumes communication between the device and the portable storage, if the certificate of the portable storage is not included in the re-updated CRL.

20. The device of claim 15, wherein the control module sends at least one application protocol data unit encrypted together with a send sequence counter value that indicates send sequence of the application protocol data unit and the data therein sent to the portable storage, and determines whether to maintain communication between the device and the portable storage by confirming a send sequence counter value of at least one application protocol data unit received from the portable storage.

21. A portable storage for digital rights management, comprising:
an interface that connects the portable storage to a device;
a storage module that stores a first certificate revocation list (CRL); and
a control module that compares issued date information of a second CRL received from the device connected through the interface with issued date information of the first CRL stored in the storage module and that updates the first CRL based on the comparison.

22. The portable storage of claim 21, wherein updating the first CRL comprises:
receiving the second CRL from the device;
replacing the first CRL with the second CRL if an issued date of the second CRL is more recent than an issued date of the first CRL, and
maintaining the first CRL in the storage module if the issued date of the second CRL is not more recent than the issued date of the first CRL.

23. The portable storage of claim 22, wherein the control module receives a certificate of the device through the interface and maintains communication between the portable storage and the device if the received certificate of the device is not included in the updated CRL.

24. The portable storage of claim 23, wherein if an interval before a next update of the updated CRL is due expires, the control module terminates communication between the portable storage and the device until the CRL stored in the storage module is re-updated.

25. The portable storage of claim 24, wherein when the CRL in the storage module is re-updated, the control module resumes communication between the portable storage and the device, if the certificate of the device is not included in the re-updated CRL.

26. The portable storage of claim 21, wherein the CRL stored in the storage module is stored when the portable storage is manufactured.

27. The portable storage of claim 21, wherein the CRL stored in the storage module is updated through a connection of the portable storage to another device or system.

28. The portable storage of claim 21, wherein the control module sends at least one application protocol data unit encrypted together with a send sequence counter value that indicates a send sequence of the application protocol data unit and the data therein, and determines whether to maintain communication between the portable storage and the device by confirming a send sequence counter value of at least one application protocol data unit received from the device.
